(19) United States
(12) Patent Application Publication
(10) Pub. No.: US 2018/0266175 A1
(43) Pub. Date: Sep. 20, 2018

(54) PRIVACY ENCLOSURE ENHANCEMENT

(71) Applicant: Jeremy York, Loganville, GA (US)

(72) Inventor: Jeremy York, Loganville, GA (US)

(21) Appl. No.: 15/460,118

(22) Filed: Mar. 15, 2017

(51) Int. Cl. E06B 9/24; E05D 7/00; E04H 1/12; E06B 3/36

(52) U.S. Cl. CPC E06B 9/24; E05D 7/009; E05Y 2900/112; E06B 3/36; E04H 1/1266

(57) ABSTRACT

An apparatus for enhancing the privacy of common privacy enclosures is presented. Two primary embodiments are disclosed. The first embodiment can be used in pre-existing enclosures. The second embodiment is designed where the privacy enhancing screen is incorporated directly into the privacy enclosure's door hinge.

### FIELD OF THE INVENTION

The field of the invention is privacy enclosures, specifically, devices designed to enhance the privacy of such enclosures.

### BACKGROUND OF THE INVENTION

Most privacy enclosures that are used in public bathrooms and changing rooms are based on a design patented by G. W. Hult in 1957 (U.S. Pat. No. 2,776,029), which features panels attached to walls and floor using specialized brackets. However, as anyone who has experienced these enclosures in a public bathroom or a changing room can attest, one significant drawback of these enclosures is the relatively large gap between the edges of the door and the adjoining pilasters, permitting those outside the enclosure to see inside. Given that the function of these enclosures is privacy, this drawback can be annoying, embarrassing, or distressing. One solution to this proposed by Crowther (U.S. Pat. No. 8,627,610) involves the use of interlocking strips to block these gaps.

### BRIEF SUMMARY OF THE INVENTION

Embodiments of the invention described herein feature a screen that can be manually positioned so that the any gap between door and pilasters is covered, blocking the view inside the enclosure. Certain embodiments designed for retrofitting into existing enclosures feature a hinge joining a baseplate that is fastened to the pilaster of a privacy enclosure, and a moveable screen. Certain other embodiments feature a moveable screen that is directly incorporated into the door hinge. These embodiments serve a secondary function to limit the range of motion of the door, i.e. they act as a doorstop in addition to enhancing privacy.

### BRIEF DESCRIPTION OF THE DRAWINGS

FIG. 1 is a view from the interior of a common bathroom stall based on the Hult design, with one embodiment of the invention.

FIG. 1A shows an overhead view of a common bathroom stall, with one embodiment of the invention.

FIG. 2 is a top view of one embodiment of the invention featuring an angled screen.

FIG. 3 is a top view another embodiment of the invention featuring a straight screen.

FIG. 4 is a top view of another embodiment of the invention featuring an angled screen with a cylindrical distal edge.

FIG. 5 is a top view of another embodiment of the invention featuring a handle at the end of the angled screen.

FIG. 6 is a top view of another embodiment of the invention featuring a handle at the end of the angled screen, and also a stop-rest.

FIG. 7 shows one embodiment of the invention in use with a common privacy enclosure.

FIG. 8 shows two embodiments of the invention involving a non-retrofit version of the privacy screen.

FIGS. 9 and 10 are top views of the non-retrofit version of the privacy screen.

FIG. 11 is a top view of one embodiment of the angled screen which is incorporated directly into a door hinge.

### DETAILED DESCRIPTION OF THE INVENTION

The invention is described in preferred embodiments in the following description with reference to the Figures, in which like numbers represent the same or similar elements. Reference throughout this specification to “one embodiment”, “an embodiment”, or similar language means that particular feature, structure, or characteristic described in connection with the embodiment is included in at least one embodiment of the present invention. Thus, appearances of the phrases “in one embodiment”, “in an embodiment”, “in certain embodiments”, and similar language throughout this specification may, but do not necessarily, all refer to the same embodiment. It is noted that, as used in this description, the singular forms “a”, “an”, and “the” include plural referents unless the context clearly dictates otherwise.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

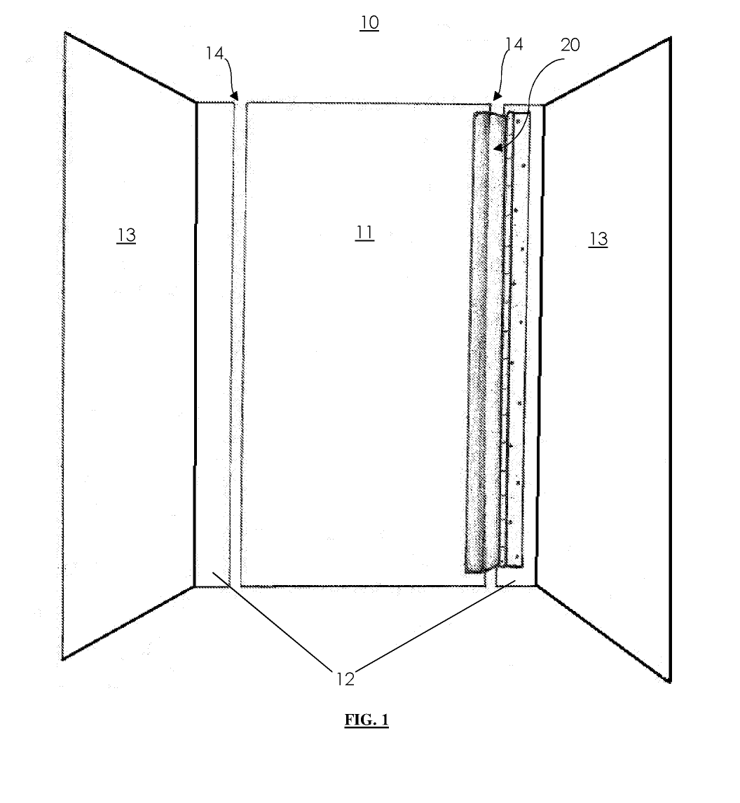

The most common privacy enclosures in use today are based on a design patented by G. W. Hult in 1957 (U.S. Pat. No. 2,776,029), which feature panels attached to walls and floor using specialized brackets. As shown in FIGS. 1 and 1A, these enclosures 10, whether in a dressing room or restroom, typically are constructed against a structural wall and feature sidewalls 13 connected to the back wall 15. Pilasters 12 are perpendicular to and connected to the sidewalls 13 of the enclosure using brackets. The entrance to the enclosure is defined by spaced apart pilasters 12 and a hinged door 11 mounted to one of the pilasters 12 by hinges to close off the entrance and provide privacy. The door 11 is latched shut when the enclosure is in use. However, the construction described above results in gaps 14 between the hinged door and the two pilasters 12 that permits those outside to see inside the enclosure. These gaps are a serious defect in the design, as they degrade the privacy for which these enclosures were designed.

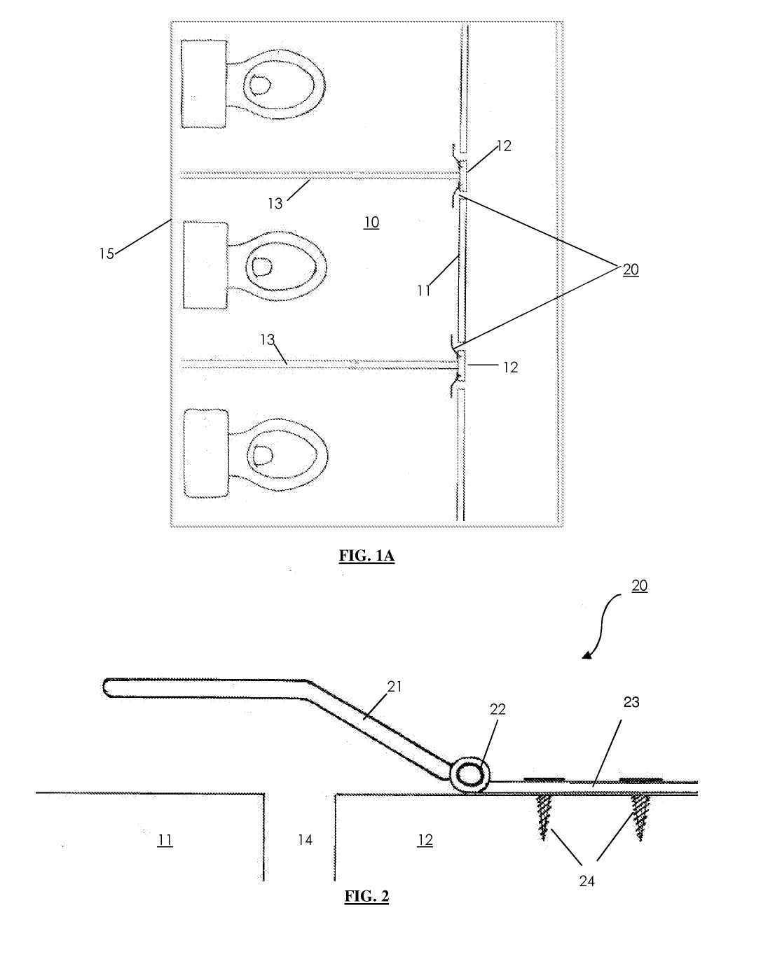

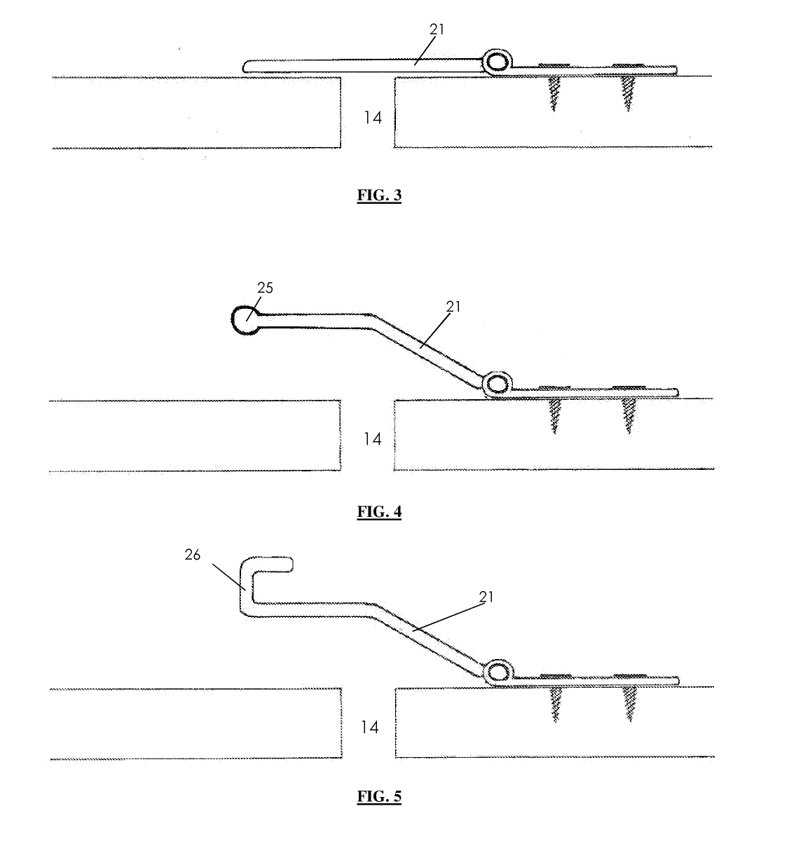

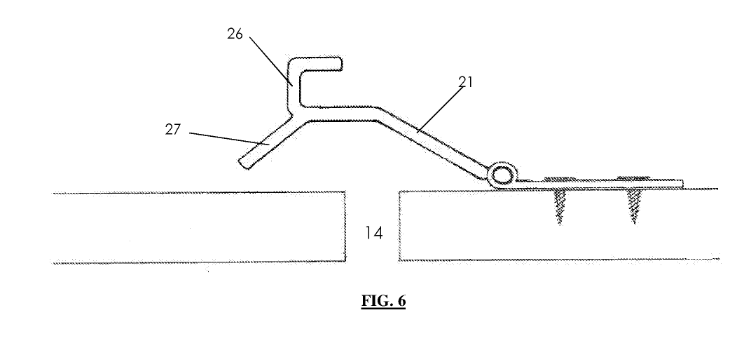

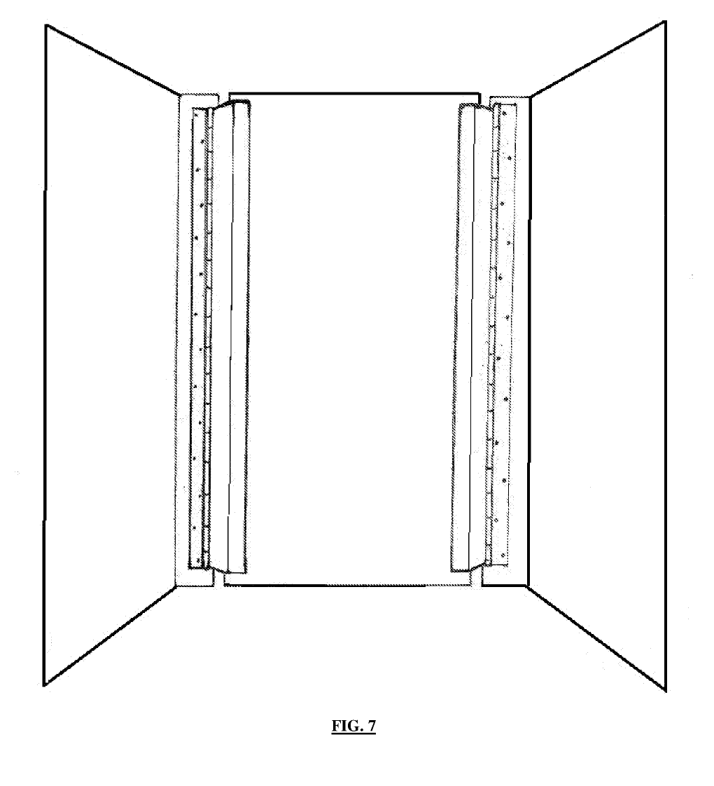

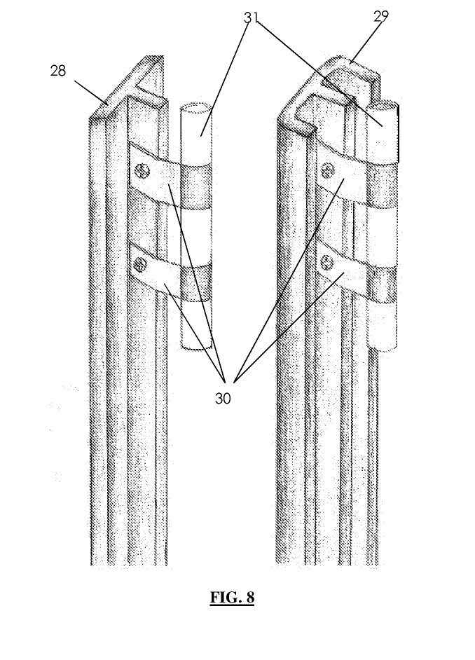

Applicant realized that this problem can be easily and economically remedied by installing a hinged screen assembly 20 shown in FIG. 1 that runs substantially the length of door 11 and completely covers gap 14, obscuring view inside the enclosure from the outside, as shown in FIGS. 1 and 1A. FIGS. 2-6 show a variety of different embodiments of the screen that can be retrofitted onto existing enclosures. The hinged screen assembly 20 features a screen 21, which is attached to hinge 22, which is secured to pilaster 12 using baseplate 23 and fasteners 24. The screen 21 shown in FIG. 2 has an angular bend to accommodate the latching mechanism of door 11. Screen 21 is sized so that it extends completely across gap 14, preventing anyone outside the enclosure from viewing anyone inside through gap 14 when screen 21 is rotated into place. FIG. 3 shows an alternate embodiment of screen 21 featuring a flat screen; this screen may have one or more holes in it to accommodate the door latch and hinges. In FIG. 4, screen 21 features a cylindrical edge 25 which facilitates moving the screen into and out of position over gap 14. FIG. 5 shows another embodiment where the long edge of the screen opposite the hinge is bent back onto itself to create a handle 26. Finally, FIG. 6 shows a variant of screen 21 with handle shown in FIG. 5, where the edge of screen 21 opposite the hinge bifurcates into a handle 26 as shown in FIG. 5, along with a stop-rest portion 27 that tends back toward the door to provide maximum obstruction of the view from outside the enclosure 10. FIG. 7 shows the retrofit version installed in a privacy enclosure covering both gaps 14.

The embodiments described above are designed to be installed in existing privacy enclosures. However, applicant also conceived the screen embodiments 28, 29 shown in FIGS. 8, 9, and 10. In these embodiments, screens 28, 29 are incorporated directly into the door hinge 31 and base plates 32. Screen 28 is simply a flat surface having a perpendicular extension to which supporting struts 30 are attached. Screen 29 is generally in the shape of a channel section having a web, i.e. center section and two span sections extending perpendicularly from the web, as shown in FIGS. 8 and 9. An extension emanating from the center of the web is attached to supporting struts 30, as shown in FIGS. 8 and 9. All embodiments of the screen 21, 28, and 29 may be constructed of any suitable material known to the art, e.g. plastic, rubber, wood, metal, etc.

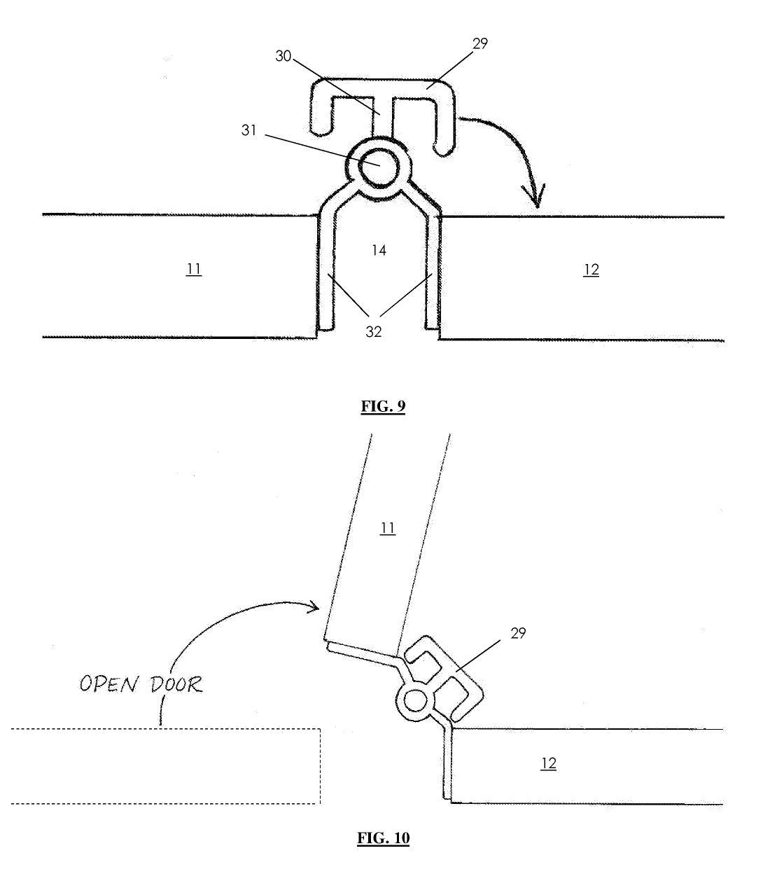

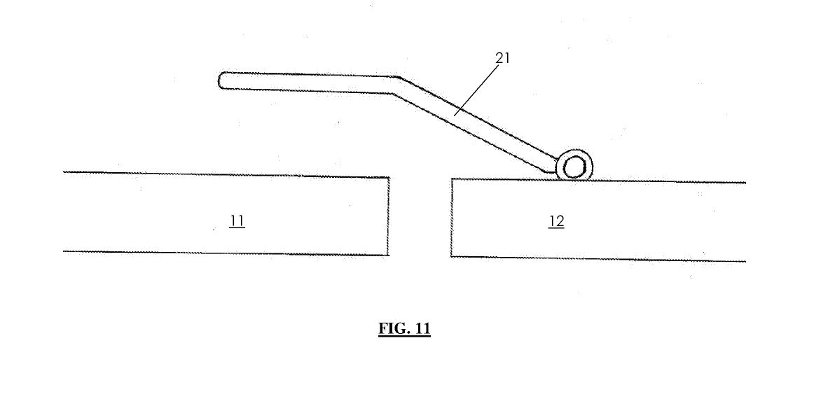

Supporting struts 30 have circular channels at one edge to incorporate door hinge post 31; the other edge is attached to screens 28, 29. FIGS. 9 and 10 show that these embodiments cover the gap 14 at all times, and also can act as a doorstop for door 11 as shown in FIG. 10. Obviously, one will appreciate that an elastomeric material such as plastic or rubber is preferred for screen embodiments 28, 29. An elastomeric material allows the edges of the screens to also act as a doorstop, as shown in FIG. 10: When the door is opened, the edges of the screen limit the angular displacement of the hinge by contacting door 11 and pilaster 12. FIG. 11 shows an alternate embodiment where the angled screen shown in FIG. 2 is incorporated directly into the door hinge; any of the embodiments of screen 21 shown in FIGS. 3-6 may be used as well.

Although the present invention has been described in detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. An apparatus for enhancing the privacy of an enclosure, comprising
a hinge;
a screen attached to said hinge such that said screen is capable of being rotated into a position where said screen obstructs the view through a gap defined by the edge of a door to a privacy enclosure and a pilaster.

2. The apparatus of claim 1, wherein said hinge is mounted via a baseplate attached on either side of said gap.

3. The apparatus of claim 1, wherein said privacy enclosure comprises a back wall, two side walls, a door, a first pilaster, and a second pilaster; wherein said door is attached to said first pilaster by at least one hinge, said door having a latch engaging a retaining structure attached to said second pilaster.

4. The apparatus of claim 2, wherein said screen is substantially flat, having two long edges and two short edges, wherein the length of said long edges is substantially equal to the height of said door.

5. The apparatus of claim 4, wherein said screen has cutouts to accommodate said hinge, said latch, and said retaining structure.

6. The apparatus of claim 2, wherein said screen has two long edges and two short edges, and the length of said long edges is substantially equal to the height of said door; wherein said screen is bent at least once on an axis that is substantially parallel to and located between said long edges.

7. The apparatus of claim 2, wherein said screen has a first long edge and a second long edge, wherein said screen is attached to said hinge at said first long edge, wherein said screen is bent at least once on an axis that is substantially parallel to and located between said first long edge and said second long edge.

8. The apparatus of claim 1, wherein said screen comprises a channel-section having a web of sufficient width to obstruct the view through said gap, wherein said channel-section is mounted to said hinge via an extension extending toward the hinge from said web, wherein the flanges of said channel section are generally oriented toward said hinge.

9. The apparatus of claim 8, wherein said screen is comprised of elastomeric material.
